(19) United States
(12) Patent Application Publication
(10) Pub. No.: US 2026/0045237 A1
(43) Pub. Date: Feb. 12, 2026

(54) ELECTRONIC DEVICE DISPLAYING IMAGE AND DISPLAY METHOD USING THE SAME

(71) Applicant: SAMSUNG ELECTRONICS CO., LTD., Suwon-si (KR)

(72) Inventor: Chansik PARK, Suwon-si (KR)

(73) Assignee: SAMSUNG ELECTRONICS CO., LTD., Suwon-si (KR)

(21) Appl. No.: 19/219,583

(22) Filed: May 27, 2025

Related U.S. Application Data
(63) Continuation of application No. PCT/KR2025/006086, filed on May 7, 2025.

(30) Foreign Application Priority Data
Aug. 9, 2024 (KR) 10-2024-0107036
Sep. 27, 2024 (KR) 10-2024-0131969

(51) Int. Cl. G09G 5/02; G09G 5/10

(52) U.S. Cl. CPC G09G 5/02; G09G 5/10; G09G 2320/0233; G09G 2320/0242; G09G 2320/0626; G09G 2320/0666

(57) ABSTRACT

Provided is an electronic device for, and method of, displaying an image, the electronic device including: a display; at least one processor; and memory storing one or more instructions that, when individually or collectively executed by the at least one processor, may cause the electronic device to: obtain an on-pixel ratio (OPR) based on input image data, determine a target luminance based on the OPR and a display set luminance, perform HDR tone mapping, using the target luminance, on the input image data, and control the display to display an image corresponding to the input image data on which HDR tone mapping is performed.

### CROSS-REFERENCE TO RELATED APPLICATIONS

This application is a continuation of an International application No. PCT/KR2025/006086 designating the United States, filed on May 7, 2025, in the Korean Intellectual Property Receiving Office, which claims priority from Korean Patent Application No. 10-2024-0107036, filed on Aug. 9, 2024, and Korean Patent Application No. 10-2024-0131969, filed on Sep. 27, 2024, in the Korean Intellectual Property Office, the disclosures of each of which are incorporated by reference herein in their entireties.

### BACKGROUND

### 1. Field

The disclosure relates to a display technology, and more specifically, to an electronic device displaying an image and a display method using the same.

### 2. Description of Related Art

High dynamic range (HDR) is a technology for displaying images by finely dividing the image contrast similar to those actually perceived (e.g., viewed or seen) by a user. HDR supports a wider color gamut and higher luminance range than standard dynamic range (SDR), thereby able to provide more vivid and realistic images.

HDR images may be classified as HDR10, which applies the same tone mapping to the entire image sequence using static metadata, or HDR10+ or Dolby vision, which differently applies tone mapping for each frame of an image using dynamic metadata.

Conventional HDR tone mapping mainly relies on the display's set luminance or maximum brightness value. As a result, conventional HDR tone mapping fails to account for the physical characteristics of the display or the actual usage environment, leading to distorted image brightness and color that deviate from the content creator's intention.

### SUMMARY

Provided is an electronic device that displays high-quality HDR images showing (e.g., reflecting) the content creator's intention while minimizing distortion of brightness and color by determining a target luminance based on a display set luminance and an on-pixel ratio (OPR) and performing HDR tone mapping based on the OPR, and a display method using the same.

According to an example embodiment, an electronic device may include: a display; at least one processor; and memory storing one or more instructions that, when individually or collectively executed by the at least one processor, cause the electronic device to: obtain an OPR based on input image data, determine a target luminance based on the OPR and a display set luminance, perform HDR tone mapping, using the target luminance, on the input image data, and control the display to display an image corresponding to the input image data on which HDR tone mapping is performed.

According to an example embodiment, the OPR may be obtained based on pixel values of each frame of the input image data.

According to an example embodiment, the one or more instructions, when individually or collectively executed by the at least one processor, may further cause the electronic device to: analyze pixel values of each frame of the input image data, and obtain, based on the pixel values, at least one of a ratio of emitting pixels to total pixels or an emitting degree.

According to an example embodiment, the one or more instructions, when individually or collectively executed by the at least one processor, may further cause the electronic device to: based on the display set luminance being equal to or less than a high brightness mode (HBM) maximum luminance, identify the target luminance as the display set luminance.

According to an example embodiment, the one or more instructions, when individually or collectively executed by the at least one processor, may further cause the electronic device to: compare the OPR with a reference OPR, and based on the OPR being equal to the reference OPR, identify the target luminance as the display set luminance.

According to an example embodiment, the one or more instructions, when individually or collectively executed by the at least one processor, may further cause the electronic device to: compare the OPR with a reference OPR, and based on the OPR being greater than the reference OPR, set the target luminance to be lower than the display set luminance.

According to an example embodiment, the one or more instructions, when individually or collectively executed by the at least one processor, may further cause the electronic device to: compare the OPR with a reference OPR, and based on the OPR being less than the reference OPR, set the target luminance to be higher than the display set luminance.

According to an example embodiment, the one or more instructions, when individually or collectively executed by the at least one processor, may further cause the electronic device to: obtain illuminance data including an illuminance of a usage environment, and determine the target luminance based on the illuminance data, the OPR, and the display set luminance.

According to an example embodiment, the one or more instructions, when individually or collectively executed by the at least one processor, may further cause the electronic device to: analyze the target luminance of each frame of the input image data, and compensate the target luminance based on a first compensation method using an infinite impulse response (IR) filter.

According to an example embodiment, the one or more instructions, when individually or collectively executed by the at least one processor, may further cause the electronic device to: analyze the target luminance of each frame of the input image data, and compensate the target luminance based on a second compensation method using an average value of target luminances of each frame of the input image data.

According to an example embodiment, the one or more instructions, when individually or collectively executed by the at least one processor, may further cause the electronic device to: analyze the target luminance for each frame of the input image data, and compensate the target luminance based on a third compensation method including incremental change of the target luminance based on a reference target luminance.

According to an example embodiment, the one or more instructions, when individually or collectively executed by the at least one processor, may further cause the electronic device to: obtain a tone mapping curve corresponding to the input image data, adjust the tone mapping curve based on the OPR, and perform HDR tone mapping on the target luminance using the adjusted tone mapping curve.

According to an example embodiment, the one or more instructions, when individually or collectively executed by the at least one processor, may further cause the electronic device to: render an image that reflects loading effect characteristics based on the OPR through the HDR tone mapping, and display the rendered image on the display.

According to an example embodiment, the one or more instructions, when individually or collectively executed by the at least one processor, may further cause the electronic device to determine the target luminance based on the OPR, the display set luminance, and characteristics of the display.

According to an example embodiment, a method of displaying an image may include: obtaining an OPR based on input image data; determining a target luminance based on the OPR and a display set luminance; performing HDR tone mapping, using the target luminance, on the input image data; and displaying an image corresponding to the input image data on which HDR tone mapping is performed.

According to an example embodiment, the OPR may be obtained based on pixel values of each frame of the input image data.

According to an example embodiment, the determining the target luminance may include: based on the display set luminance being equal to or less than a HBM maximum luminance, identifying the target luminance as the display set luminance.

According to an example embodiment, the determining the target luminance may further include: comparing the OPR with a reference OPR; and based on the OPR being equal to the reference OPR, identifying the target luminance as the display set luminance.

According to an example embodiment, the determining the target luminance may further include: comparing the OPR with a reference OPR; and based on the OPR being greater than the reference OPR, setting the target luminance to be lower than the display set luminance.

According to an example embodiment, the determining the target luminance may further include: comparing the OPR with a reference OPR; and based on the OPR being less than the reference OPR, setting the target luminance to be higher than the display set luminance.

According to an example embodiment, a non-transitory computer readable medium has instructions stored therein, which when executed by at least one processor cause the at least one processor to execute a method of displaying an image, the method including: obtaining an OPR based on input image data; determining a target luminance based on the OPR and a display set luminance; performing HDR tone mapping, using the target luminance, on the input image data; and displaying an image corresponding to the input image data on which HDR tone mapping is performed.

Effects achievable in example embodiments of the disclosure are not limited to the above-mentioned effects, but other effects not mentioned may be derived and understood from the following description by one of ordinary skill in the art to which the disclosure pertains. In other words, unintended effects in practicing embodiments of the disclosure may also be derived by one of ordinary skill in the art from example embodiments of the disclosure.

### BRIEF DESCRIPTION OF THE DRAWINGS

The above and other aspects and features of certain embodiments of the present disclosure will be more apparent from the following description taken in conjunction with the accompanying drawings, in which:

FIG. 1 is a block diagram illustrating an example electronic device in a network environment according to one or more embodiment(s);

FIG. 2 is a block diagram illustrating an example configuration of an electronic device according to one or more embodiment(s);

FIG. 3 is a flowchart illustrating example operations of an electronic device according to one or more embodiment(s);

FIG. 4 is a conceptual view illustrating an example operation of determining a target luminance by an electronic device according to one or more embodiment(s);

FIG. 5 is a flowchart illustrating an example operation of determining a target luminance by an electronic device according to one or more embodiment(s);

FIG. 6 is a view illustrating Equation 1 and Equation 2 used to calculate a target luminance by an electronic device according to one or more embodiment(s);

FIG. 7 is a table illustrating an example on-pixel ratio and a display set luminance according to one or more embodiment(s);

FIG. 8 is a conceptual view illustrating an example operation of determining a target luminance by an electronic device according to one or more embodiment(s);

FIG. 9 is a conceptual view illustrating an example operation of compensating for a target luminance by an electronic device according to one or more embodiment(s);

FIGS. 10A, 10B, and 10C are views illustrating various compensation methods for compensating for a target luminance by an electronic device according to one or more embodiment(s);

FIG. 11 is a flowchart illustrating an example operation of performing HDR tone mapping by an electronic device according to one or more embodiment(s); and

FIGS. 12A, 12B, and 12C are views illustrating an example tone mapping curve used for HDR tone mapping by an electronic device according to one or more embodiment(s).

### DETAILED DESCRIPTION

One or more embodiment(s) of the disclosure are now described with reference to the accompanying drawings in such a detailed manner as to be practiced by one of ordinary skill in the art. However, the disclosure may be implemented in other various forms and is not limited to the embodiments set forth herein. The same or similar reference denotations may be used to refer to the same or similar elements throughout the specification and the drawings. Further, for clarity and brevity, no description is made of well-known functions and configurations in the drawings and relevant descriptions.

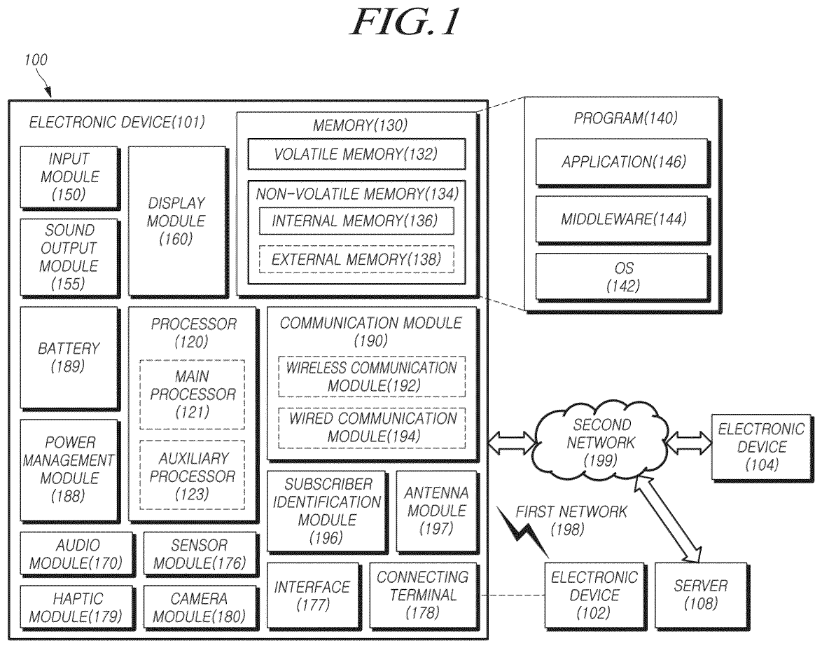

FIG. 1 is a block diagram illustrating an electronic device in a network environment according to one or more embodiment(s) of the disclosure.

In FIG. 1, the electronic device 101 in the network environment 100 may communicate with an electronic device 102 via a first network 198 (e.g., a short-range wireless communication network), or an electronic device 104 or a server 108 via a second network 199 (e.g., a long-range wireless communication network). According to one or more embodiment(s), the electronic device 101 may communicate with the electronic device 104 via the server 108. According to one or more embodiment(s), the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In one or more embodiment(s), at least one (e.g., the connecting terminal 178) of the components may be omitted from the electronic device 101, or one or more other components may be added in the electronic device 101. According to one or more embodiment(s), some (e.g., the sensor module 176, the camera module 180, or the antenna module 197) of the components may be integrated into a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to one or more embodiment(s), as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to one or more embodiment(s), the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be configured to use lower power than the main processor 121 or to be specified for a designated function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to one or more embodiment(s), the auxiliary processor 123 (e.g., an image signal processor or a communication processor) may be implemented as part of another component (e.g., the camera module 180 or the communication module 190) functionally related to the auxiliary processor 123. According to one or more embodiment(s), the auxiliary processor 123 (e.g., the neural processing unit) may include a hardware structure specified for artificial intelligence model processing. The artificial intelligence model may be generated via machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by other component (e.g., the processor 120) of the electronic device 101, from the outside (e.g., a user) of the electronic device 101. The input module 150 may include, for example, a microphone, a mouse, a keyboard, keys (e.g., buttons), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to one or more embodiment(s), the receiver may be implemented as separate from, or as part of the speaker.

The display module 160 may visually provide information to the outside (e.g., a user) of the electronic device 101. The display 160 may include, for example, a display, a hologram device, or a projector and control circuitry to control a corresponding one of the display, hologram device, and projector. According to one or more embodiment(s), the display 160 may include a touch sensor configured to detect a touch, or a pressure sensor configured to measure the intensity of a force generated by the touch.

The audio module 170 may convert a sound into an electrical signal and vice versa. According to one or more embodiment(s), the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to one or more embodiment(s), the sensor module 176 may include, for example, a gesture sensor, a gyro sensor, an atmospheric pressure sensor, a magnetic sensor, an accelerometer, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to one or more embodiment(s), the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to one or more embodiment(s), the connecting terminal 178 may include, for example, an HDMI connector, a USB connector, an SD card connector, or an audio connector (e.g., a headphone connector).

The haptic module 179 may convert an electrical signal into a mechanical stimulus (e.g., a vibration or motion) or electrical stimulus which may be recognized by a user via his tactile sensation or kinesthetic sensation. According to one or more embodiment(s), the haptic module 179 may include, for example, a motor, a piezoelectric element, or an electric stimulator.

The camera module 180 may capture a still image or moving images. According to one or more embodiment(s), the camera module 180 may include one or more lenses, image sensors, image signal processors, or flashes.

The power management module 188 may manage power supplied to the electronic device 101. According to one or more embodiment(s), the power management module 188 may be implemented as at least part of, for example, a power management integrated circuit (PMIC).

The battery 189 may supply power to at least one component of the electronic device 101. According to one or more embodiment(s), the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to one or more embodiment(s), the communication module 190 may include a wireless communication module 192 (e.g., a cellular communication module, a short-range communication module, or a global navigation satellite system (GNSS) communication module) or a wired communication module 194 (e.g., a local area network (LAN) communication module or a power line communication (PLC) module). A corresponding one of these communication modules may communicate with the external electronic device 104 via a first network 198 (e.g., a short-range communication network, such as Bluetooth™, wireless-fidelity (Wi-Fi) direct, or infrared data association (IrDA)) or a second network 199 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The communication module 192 may identify or authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to one or more embodiment(s), the communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device). According to one or more embodiment(s), the antenna module 197 may include one antenna including a radiator formed of a conductor or conductive pattern formed on a substrate (e.g., a printed circuit board (PCB)). According to one or more embodiment(s), the antenna module 197 may include a plurality of antennas (e.g., an antenna array). In this case, at least one antenna appropriate for a communication scheme used in a communication network, such as the first network 198 or the second network 199, may be selected from the plurality of antennas by, e.g., the communication module 190. The signal or the power may then be transmitted or received between the communication module 190 and the external electronic device via the selected at least one antenna. According to one or more embodiment(s), other parts (e.g., radio frequency integrated circuit (RFIC)) than the radiator may be further formed as part of the antenna module 197.

According to one or more embodiments, the antenna module 197 may form a mmWave antenna module. According to one or more embodiment(s), the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to one or more embodiment(s), instructions or data may be transmitted or received between the electronic device 101 and the external electronic device 104 via the server 108 coupled with the second network 199. The external electronic devices 102 or 104 each may be a device of the same or a different type from the electronic device 101. According to one or more embodiment(s), all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an Internet-of-things (IoT) device. The server 108 may be an intelligent server using machine learning and/or a neural network. According to one or more embodiment(s), the external electronic device 104 or the server 108 may be included in the second network 199. The electronic device 101 may be applied to intelligent services (e.g., smart home, smart city, smart car, or health-care) based on 5G communication technology or IoT-related technology.

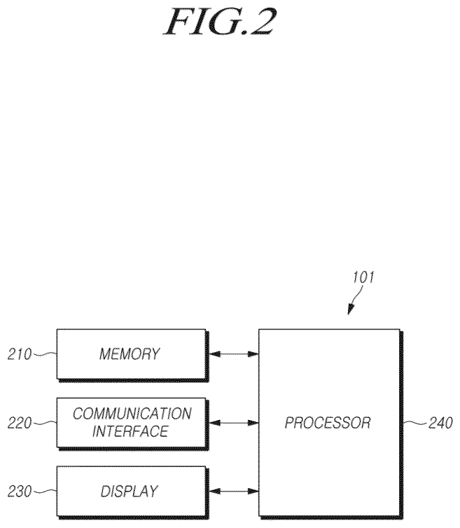

FIG. 2 is a block diagram illustrating an example configuration of an electronic device 101 according to one or more embodiment(s).

In FIG. 2, an electronic device 101 may include memory 210, a communication interface 220, a display module 230, and/or a processor 240.

The memory 210 may store various programs, data, and/or commands, used in the electronic device 101. Further, the memory 210 may store various information according to one or more embodiment(s) of the disclosure.

In one or more embodiment(s), the memory 210 may be implemented as an internal memory such as ROM (e.g., electrically erasable programmable read-only memory (e.g., EEPROM)) or RAM included in at least one processor 240, or may be implemented as a separate memory from the at least one processor 240. In this case, the memory 210 may be implemented in the form of a memory embedded in the electronic device 101 or may be implemented in the form of a memory that may be attached to or detached from the electronic device 101 depending on the purpose of data storage. For example, data for driving the electronic device 101 may be stored in a memory embedded in the electronic device 101, and data for extended functions of the electronic device 101 may be stored in a memory that may be attached to or detached from the electronic device 101.

The processor 240 (including the processor 120 of FIG. 1) may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

The memory embedded in the electronic device 101 may be implemented as at least one of volatile memory (e.g., dynamic random access memory (DRAM), static RAM (SRAM), or synchronous dynamic RAM (SDRAM)), or non-volatile memory (e.g., one time programmable read-only memory (OTPROM), programmable ROM (PROM), erasable and programmable ROM (EPROM), electrically erasable and programmable ROM (EEPROM), mask ROM, flash ROM, flash memory (e.g., NAND flash or NOR flash), hard drive, or solid state drive (SSD)), and the memory attachable to/detachable from the electronic device 101 may be implemented as a memory card (e.g., compact flash (CF), secure digital (SD), micro secure digital (micro-SD), mini secure digital (mini-SD), extreme digital (xD), multi-media card (MMC)), or external memory (e.g., USB memory) connectable to a USB port.

The communication interface 220 may be a component of the electronic device 101 configured to communicate with external devices such as an external source device or an image output device 200. The communication interface 220 may include at least one wireless communication module and/or at least one wired communication module. Each communication module may be implemented in the form of at least one hardware chip. The wireless communication module may include at least one of a Wi-Fi module, a bluetooth module, an infrared communication module, or other communication modules. Further, the communication interface may include at least one communication chip that performs communication according to various wireless communication standards such as ZigBee, 3rd generation (3G), 3rd generation partnership project (3GPP), long-term evolution (LTE), LTE-advanced (LTE-A), 4th generation (4G), and/or 5th generation (5G).

The wired communication module may include at least one of, e.g., a LAN module, an Ethernet module, a pair cable, a coaxial cable, an optical fiber cable, or an ultra-wideband (UWB) module. The communication interface 220 may be implemented in various forms as described above and may transmit and receive various signals by performing communication with external devices.

The display 230 refers to a component for displaying various contents. The display 230 may be implemented as a display including a self-luminous element or a display including a non-self-luminance element and a backlight. For example, it may be implemented as various types of displays such as liquid crystal display (LCD), organic light emitting diodes (OLED) display, light emitting diodes (LED) display, micro LED display, mini LED display, plasma display panel (PDP) display, quantum dot (QD) display, and/or quantum light-emitting diodes (QLED) display. The display 230 may also include a driving circuit that may be implemented in the form of an a-Si TFT, a low temperature polysilicon (LTPS) TFT, and/or an organic TFT (OTFT) and/or a backlight unit.

The display 230 may be implemented as a touch screen coupled to a touch sensor, a flexible display, a rollable display, a 3D display, and/or a display in which a plurality of displays are physically connected.

At least one processor 240 controls the overall operation of the electronic device 101. Specifically, at least one processor 240 may be connected to each component of the electronic device 101 to control the overall operation of the electronic device 101. For example, at least one processor 240 may be operatively connected to the memory 210, the communication interface 220 and/or the display 230.

The processor 240 may be composed of one or more processor(s). At least one processor 240 may perform the operation of the electronic device 101 according to one or more embodiments by executing at least one instruction stored in the memory 210. At least one processor 240 may include one or more of a CPU, a GPU, an accelerated processing unit (APU), a many integrated core (MIC), a digital signal processor (DSP), a NPU, a hardware accelerator, or a machine learning accelerator. The at least one processor 240 may control one or any combination of other components of the electronic device 101 and may perform an operation or data processing related to communication. At least one processor 240 may, individually or collectively, execute one or more programs or instructions stored in the memory. For example, at least one processor may execute one or more instructions stored in the memory, thereby performing a method according to one or more embodiments.

When the method, according to one or more embodiments, includes a plurality of operations, the plurality of operations may be performed by one processor or by a plurality of processors. For example, when a first operation, a second operation, and a third operation are performed in a method according to one or more embodiments, all of the first operation, the second operation, and the third operation may be performed by a first processor, or the first operation and the second operation may be performed by the first processor (e.g., a general-purpose processor), and the third operation may be performed by a second processor (e.g., an artificial intelligence-only processor).

At least one processor 240 may be implemented as a single core processor including one core or may be implemented as one or more multi-core processors including a plurality of cores (e.g., homogeneous multi-core or heterogeneous multi-core). When at least one processor 240 is implemented as a multi-core processor, each of the plurality of cores included in the multi-core processor may comprise a processor internal memory such as a cache memory and an on-chip memory, and a common cache shared by the plurality of cores may be included in the multi-core processor. Further, each of the plurality of cores (or some of the plurality of cores) included in the multi-core processor may independently read and execute program instructions to implement a method according to one or more embodiments, or all (or some) of the plurality of cores may be associated to read and execute program instructions to implement a method according to one or more embodiments.

When the method according to one or more embodiments includes a plurality of operations, the plurality of operations may be performed by one of the plurality of cores included in the multi-core processor or by the plurality of cores. For example, when a first operation, a second operation, and a third operation are performed in a method according to one or more embodiments, all of the first operation, the second operation, and the third operation may be performed by a first core included in the multi-core processor, or the first operation and the second operation may be performed by the first core included in the multi-core processor, and the third operation may be performed by a second core included in the multi-core processor.

In one or more embodiments of the disclosure, the term processor may mean a system on chip (SoC) where at least one processor and other electronic components are integrated, a single core processor, a multi-core processor, or a core included in a single core processor or a multi-core processor, where the core may be implemented as a CPU, GPU, APU, MIC, DSP, NPU, hardware accelerator, and/or machine learning accelerator, but the embodiments are not limited thereto. Hereinafter, for convenience of description, at least one processor 240 may be referred to as the processor 240.

The processor 240 may determine a target luminance considering an OPR along with display set luminance, and perform HDR tone mapping based on the OPR, thereby minimizing brightness and color distortion, and displaying a high-quality HDR image that meets the intention of the content creator. For example, the processor 240 may calculate an OPR based on input image data, determine a target luminance based on the OPR and display set luminance, perform HDR tone mapping using the target luminance, and display an image where the HDR tone mapping has been performed.

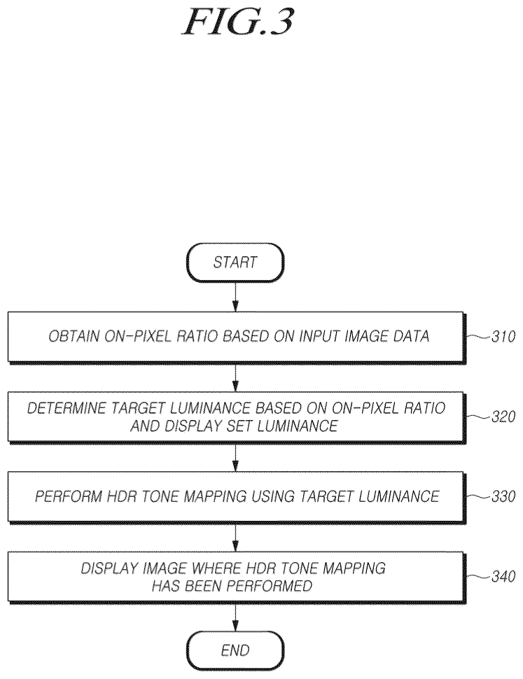

FIG. 3 is a flowchart illustrating example operations of an electronic device 101 according to one or more embodiment(s).

In FIG. 3, the electronic device 101 may determine target luminance based on an OPR along with display set luminance, and perform HDR tone mapping based on the OPR. For example, the electronic device 101 may obtain the OPR based on input image data (operation 310), determine the target luminance based on the OPR and display set luminance (operation 320), perform HDR tone mapping using the target luminance (operation 330), and display an image where the HDR tone mapping has been performed (operation 340).

According to one or more embodiment(s), in operation 310, the electronic device 101 may obtain an OPR based on input image data. The electronic device 101 may calculate an OPR based on input image data. For example, the electronic device 101 may analyze pixel values for each frame of the input image data and calculate the ratio of emitting pixels to all the pixels, based on the pixel values.

The electronic device 101 may determine whether each pixel is in a light emitting state by analyzing the pixel values of each frame of the input image data. For example, the electronic device 101 may determine whether a pixel is in a light emitting state based on whether the luminance value of the pixel is greater than or equal to a predetermined threshold. The electronic device 101 may determine whether each pixel in the frame emits light and count the number of pixels emitting light.

The electronic device 101 may calculate the total number of pixels in each frame and calculate a ratio of emitting pixels, i.e., the OPR, by dividing the number of the emitting pixels by the total number of pixels. For example, the electronic device 101 may obtain an individual OPR value for each frame by repeatedly performing the above-described operation on each frame of the input image data.

According to one or more embodiment(s), the electronic device may calculate an OPR value of a frame (or image) based on a ratio of the sum of red, green, and blue (RGB) maximum values of each pixel of the frame (or image) to the maximum luminance of the frame (or image).

Further, the electronic device 101 may calculate a representative OPR value for the plurality of frames by calculating an average value of the OPR values calculated for the plurality of frames. For example, the electronic device 101 may determine the target luminance using the representative OPR value. For example, the electronic device 101 may adjust a tone mapping curve to perform HDR tone mapping using the representative OPR value.

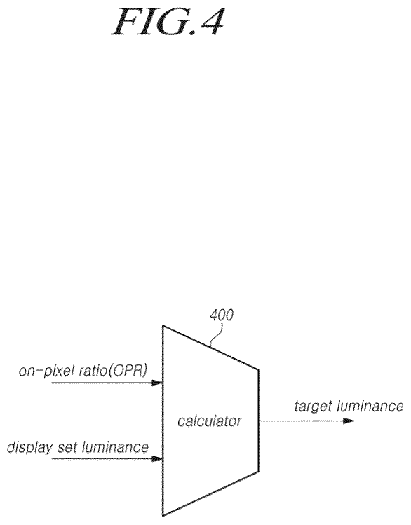

According to one or more embodiment(s), in operation 320, the electronic device 101 may determine the target luminance based on the OPR and the display set luminance. Hereinafter, operation 320 of the electronic device 101 is described in detail with reference to FIGS. 4 to 10C.

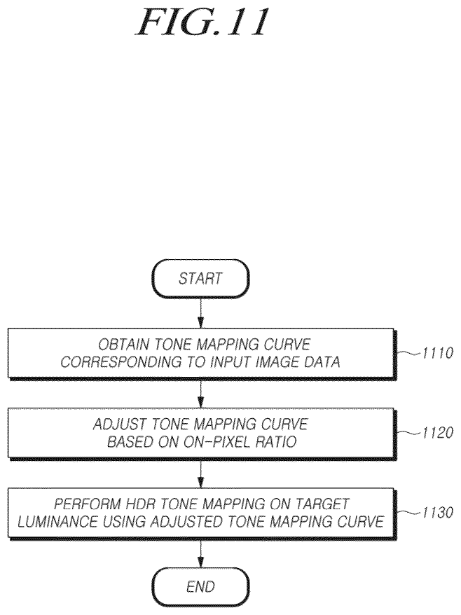

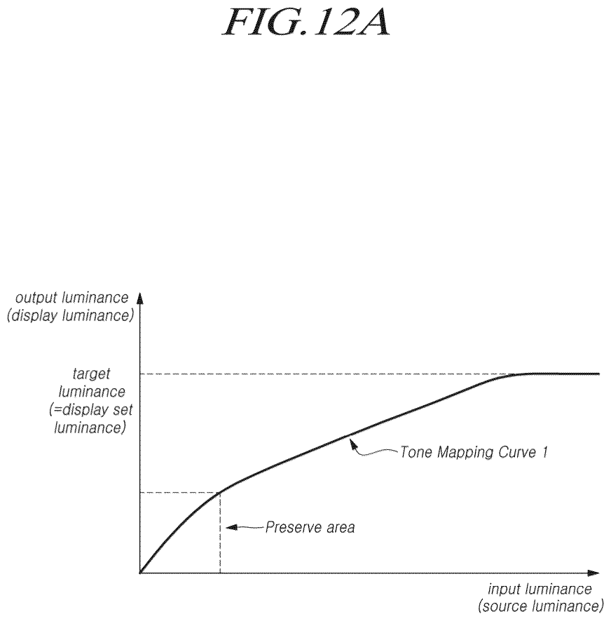

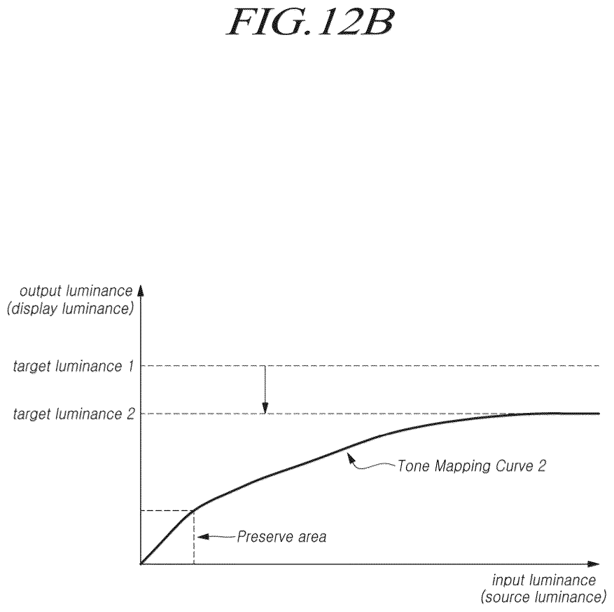

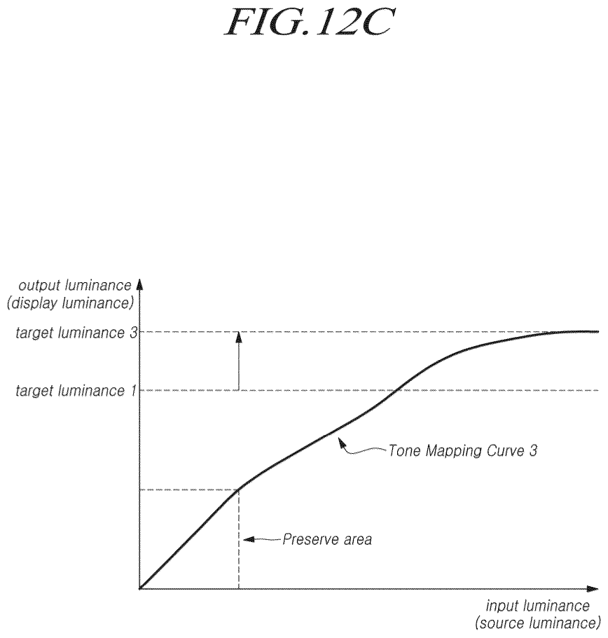

According to one or more embodiment(s), in operation 330, the electronic device 101 may perform HDR tone mapping using the target luminance, thereby generating an HDR tone mapped image. Hereinafter, operation 330 of the electronic device 101 is described in detail with reference to FIGS. 11 to 12C.

According to one or more embodiment(s), in operation 340, the electronic device 101 may display the image where the HDR tone mapping has been performed (i.e., the HDR tone mapped image). For example, the electronic device 101 may display an image with reduced color distortion. The electronic device 101 may render the image by considering the loading effect characteristics based on the OPR via the HDR tone mapping.

According to one or more embodiment(s), the electronic device 101 may correct the brightness reduction that may occur due to a loading effect by analyzing the OPR and the power consumption characteristics of the display panel in the rendering process. The loading effect is a phenomenon in which the average brightness of the entire screen decreases as the ratio of light emitting pixels increases and may be seen in an active-matrix organic light-emitting diode (AMOLED) display. The electronic device 101 may match the luminance of the image to be displayed to the set target luminance by determining the final target luminance of each pixel considering the OPR. The electronic device 101 may prevent color distortion or brightness decrease caused by physical limitations of the display and provide a more natural and accurate image by rendering the image while considering the loading effect that may occur in the HDR tone mapping process.

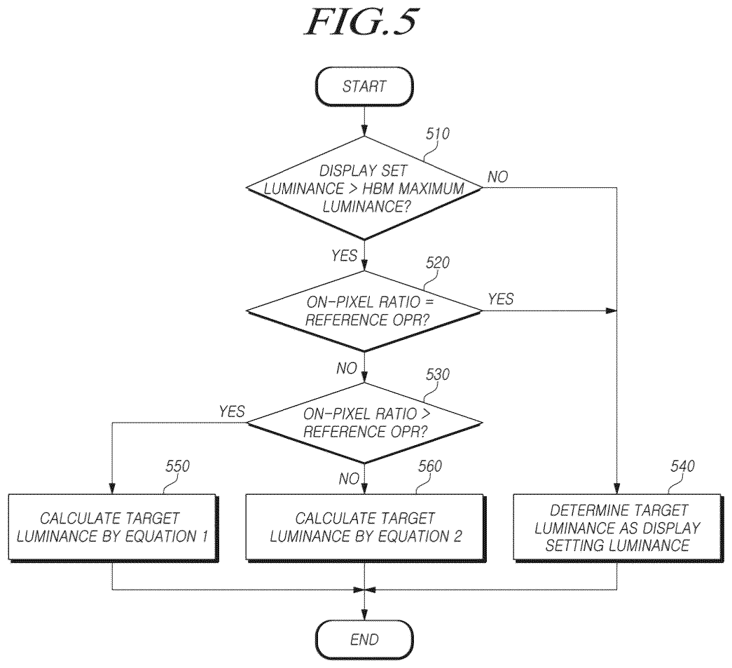

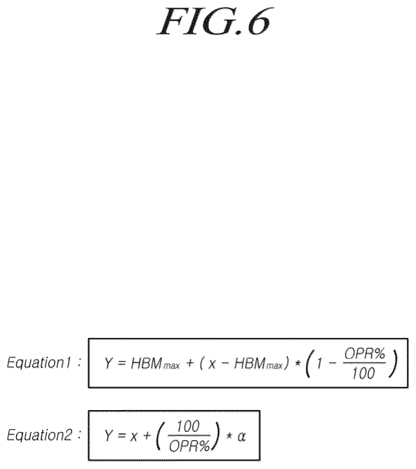

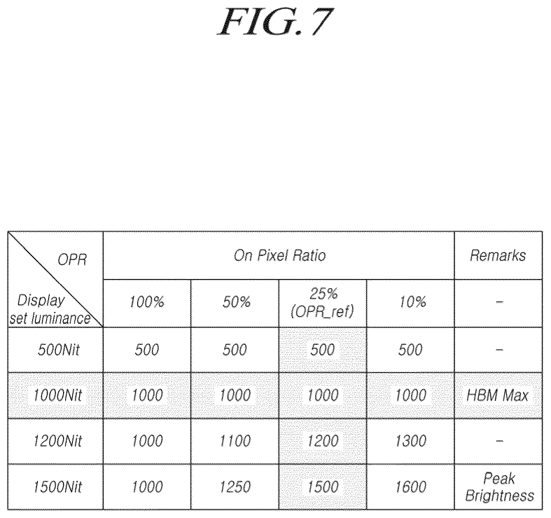

FIG. 4 is a conceptual view illustrating an example operation of determining a target luminance by an electronic device 101 according to one or more embodiment(s). FIG. 5 is a flowchart illustrating an example operation of determining a target luminance by an electronic device 101 according to one or more embodiment(s). FIG. 6 is a view illustrating Equation 1 and Equation 2 used to calculate a target luminance by an electronic device 101 according to one or more embodiments. FIG. 7 is a table illustrating an example OPR and a display set luminance according to one or more embodiment(s).

The display set luminance may be a brightness level set by the user or designated (e.g., predetermined) as a default setting in the electronic device 101. For example, the display set luminance may be a maximum value of brightness targeted by the electronic device 101 when playing content from input image data. For example, the display set luminance may be set in nits (candela/square meter).

In FIG. 4, the electronic device 101 may determine maximum luminance, which is a reference for HDR tone mapping, using the display set luminance and the OPR. For example, the electronic device 101 may determine the maximum brightness to output content according to input image data based on the display set luminance and the OPR. For example, the electronic device 101 may calculate a target luminance from the display set luminance and the OPR using a target luminance calculator 400.

As illustrated in FIG. 5, the electronic device 101 may determine whether the display set luminance is greater than HBM maximum luminance (operation 510). Herein, the HBM maximum brightness may represent the maximum brightness that the electronic device 101 may output in a HBM. For example, the HBM may be a mode in which the brightness of the display is temporarily maximized to increase the visibility of the display in an environment with strong external lighting, such as in strong sunlight. For example, the HBM maximum luminance may refer to the maximum brightness limit that the hardware of the display may physically support, ensuring the display can clearly display content in a specific environment.

When the display set luminance is smaller than or equal to the HBM maximum luminance, the electronic device 101 may determine the target luminance as the display set luminance. For example, when the display set luminance is smaller than or equal to the HBM maximum luminance, the actual maximum luminance may be the same as the display set luminance regardless of the OPR. For example, as illustrated in FIG. 7, when the display set luminance (e.g. 500 nits or 1000 nits) is less than or equal to the HBM maximum brightness (e.g. 1000 nits), the actual maximum luminance may be equal to the display set luminance regardless of the OPR.

The electronic device 101 may compare the OPR with a reference OPR (operation 520 and operation 530). Here, the reference OPR may refer to an OPR when the actual maximum luminance and the display set luminance match. For example, the reference OPR may represent the OPR under conditions in which the actual maximum luminance remains the same as the display set luminance regardless of the luminance change in the display set luminance. For example, the reference OPR may be a reference point capable of performing optimal brightness in the HBM mode. For example, if the OPR is larger (e.g., greater) or smaller (e.g., less) than the reference OPR, the actual maximum luminance may be different from the display set luminance. For example, as illustrated in FIG. 6, if the OPR is greater than or less than the reference OPR, the electronic device 101 may calculate the target luminance using Equation 1 or Equation 2. For example, as illustrated in FIG. 7, the reference OPR may be an OPR (e.g., 25%) where the actual maximum luminance remains the same brightness as the display set luminance regardless of the luminance change in the display set luminance.

In one or more embodiment(s), if the OPR is the same as the reference OPR, the electronic device 101 may determine the target luminance as the display set luminance. For example, if the OPR is the same as the reference OPR, the actual maximum luminance may be the same as the display set luminance.

In one or more embodiment(s), if the OPR is greater than the reference OPR, the electronic device 101 may calculate the target luminance using the following Equation 1.

$$Y = {HBM}_{max} + ( x - {HBM}_{max} ) ⋆ ( 1 - \frac{OPR \%}{100} ) \qquad Equation 1$$

Here, Y is the target luminance, HBMₘₐₓ is the HBM maximum luminance, X is the display set luminance, and OPR is the OPR.

For example, as illustrated in FIG. 7, if the OPR is greater than the reference OPR, the actual maximum luminance may be smaller (or less) than the display set luminance. Therefore, when the OPR is greater than the reference OPR, the electronic device 101 may calculate a target luminance smaller (or less) than the display set luminance by using Equation 1, which accounts for the OPR.

In one or more embodiment(s), if the OPR is smaller (or less) than the reference OPR, the electronic device 101 may cause the target luminance to be calculated using the following Equation 2.

$$Y = x + ( \frac{100}{OPR \%} ) * α \qquad Equation 2$$

Here, Y is the target luminance, X is the display set luminance, OPR is the OPR, and a is the luminance correction parameter.

For example, as illustrated in FIG. 7, if the OPR is smaller (or less) than the reference OPR, the actual maximum luminance may be greater than the display set luminance. Therefore, if the OPR is smaller (or less) than the reference OPR, the electronic device 101 may calculate a target luminance greater than the display set luminance by using Equation 2, which accounts for (e.g., taking into consideration) the OPR.

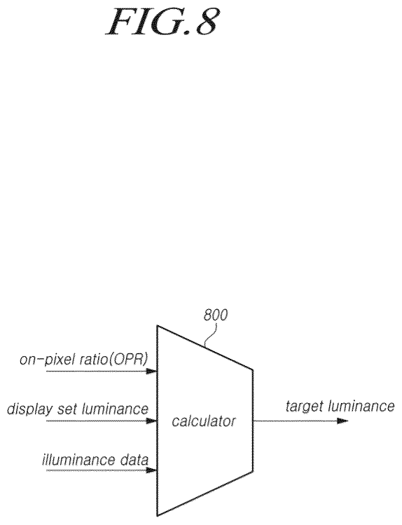

FIG. 8 is a conceptual view illustrating an example operation of determining a target luminance by an electronic device 101 according to one or more embodiment(s).

In FIG. 8, the electronic device 101 may receive or obtain illuminance data including illuminance of the usage environment and determine a target luminance using the illuminance data. For example, as illustrated in FIG. 8, the electronic device 101 may determine the target luminance by additionally applying the illuminance data to the OPR and the display set luminance. For example, the electronic device 101 may calculate a target luminance from the display set luminance, the OPR, and the illuminance data using the target luminance calculator 800.

For example, the electronic device 101 may collect, in real-time, the illuminance of the usage environment in which the electronic device 101 is used via an illuminance sensor. The electronic device 101 may generate illuminance data of the usage environment based on the collected illuminance.

The electronic device 101 may analyze the illuminance data and determine a target luminance based on the illuminance data. The electronic device 101 may adjust the target luminance based on the illuminance data. For example, when the ambient illuminance is high (e.g., under strong sunlight), the electronic device 101 may decrease the target luminance. In this case, the electronic device 101 may perform HDR tone mapping based on the decreased target luminance to have an overall increased tone mapping value for the entire image, so that the image may look brighter. Conversely, when ambient illumination is low (e.g., in a dark indoor environment), the electronic device 101 may increase the target luminance to reduce unnecessary power consumption.

In one or more embodiment(s), the electronic device 101 may calculate an optimal target luminance based on the illuminance data, and the OPR and display set luminance previously calculated. For example, the electronic device 101 may adjust the target luminance by applying a luminance correction coefficient based on illuminance calculated via a predefined table or algorithm.

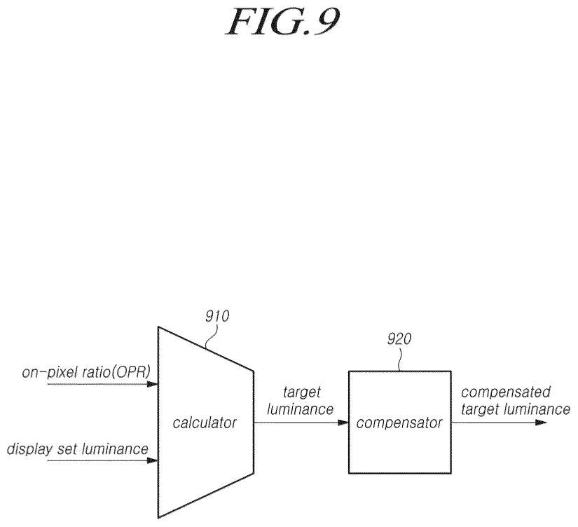

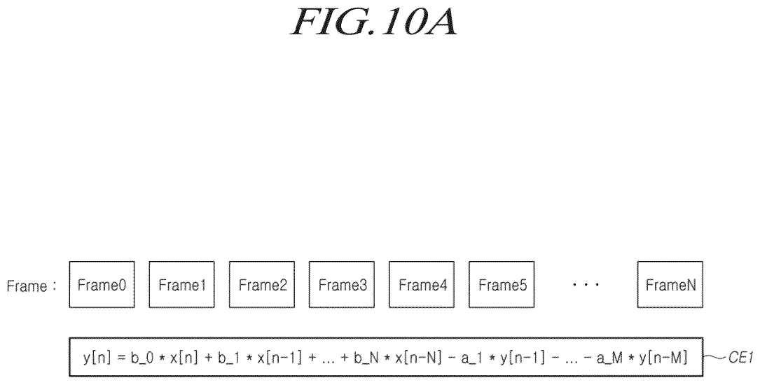

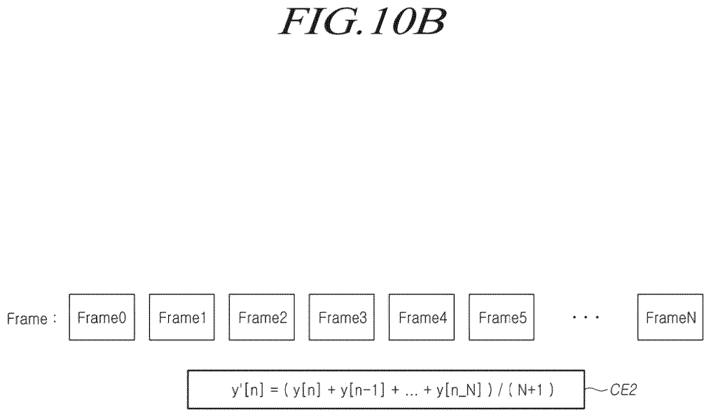

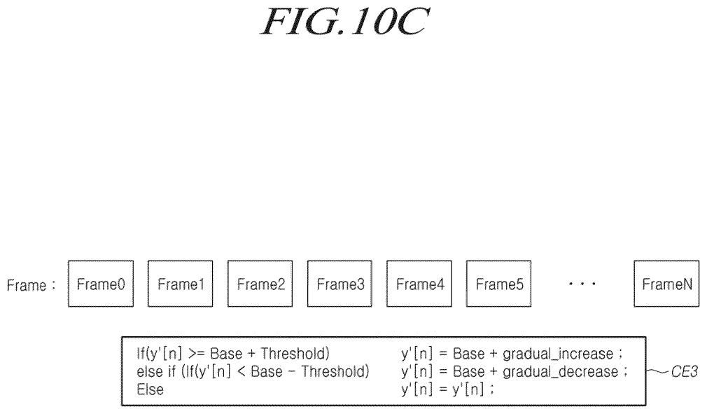

FIG. 9 is a conceptual view illustrating an example operation of compensating for a target luminance by an electronic device 101 according to one or more embodiment(s). FIGS. 10A to 10C are views illustrating various compensation methods for compensating for a target luminance by an electronic device 101 according to one or more embodiment(s).

In FIG. 9, the electronic device 101 may determine a target luminance using a display set luminance and an OPR and compensate for the target luminance using at least one compensation equation. For example, the electronic device 101 may obtain (e.g., calculate or determine) a target luminance from the display set luminance and the OPR using a target luminance calculator 910. For example, the electronic device 101 may output a compensated target luminance by compensating for the target luminance using the target luminance compensator 920.

In one or more embodiment(s), the electronic device 101 may compensate for the target luminance using an IIR filter. For example, as illustrated in FIG. 10A, the electronic device 101 may analyze the target luminance for each frame of the input image data and compensate for the target luminance using the following Compensation Equation 1.

$$y [ n ] = b\_ 0 ⋆ x [ n ] + b\_ 1 ⋆ x [ n - 1 ] + … + b\_N * x [ n - N ] ⋆ a\_ 1 * y [ n - 1 ] - … - a\_M * y [ n - M ] \qquad Compensation Equation 1$$

Here, x[n] is the input target luminance of the current frame, and y[n] is the final target luminance of the current frame. x[n−x] is the input target luminance of the previous frame, and Y[n−x] is the final target luminance of the previous frame. N is the frame window to be used, and M is the number of previous frames to be used. b_x is the feed forward coefficient, and a_x is the feedback coefficient.

For example, the electronic device 101 may provide a change in target luminance using the IIR filter. For example, the electronic device 101 may reduce flickering due to sudden luminance changes by calculating the final target luminance considering the target luminance of the previous frame as well as the target luminance of the current frame. In one or more embodiment(s), the electronic device 101 may compensate for the target luminance using an average value of the target luminances of a plurality of frames. For example, as illustrated in FIG. 10B, the electronic device 101 may analyze the target luminance for each frame of the input image data and compensate for the target luminance using the following compensation equation 2.

$${y}^{′} [ n ] = ( y [ n ] + y [ n - 1 ] + … + y [ n\_N ] ) / ( N + 1 ) \qquad Compensation Equation 2$$

Here, y′[n] is the final target luminance of the current frame, and y[n−x] is the final target luminance of the previous frame. N is the frame window to be used.

For example, the electronic device 101 may determine a final target luminance by averaging the target luminances value of a predetermined number of frames N. By determining the final target luminance as the average value of the target luminances of the plurality of frames, the electronic device 101 may address (e.g., alleviate) a sudden change in luminance in an image having frequent brightness fluctuations and minimize flickering.

In one or more embodiment(s), the electronic device 101 may compensate for the target luminance so that the change in the target luminance is incrementally (e.g., gradually) changed. For example, as illustrated in FIG. 10C, the electronic device 101 may analyze the target luminance for each frame of the input image data and compensate for the target luminance using the following Compensation Equation 3.

$$\begin{matrix}\begin{matrix}If ( {y}^{′} [ n ] >= Base + \\ Threshold )\end{matrix} & \begin{matrix}{y}^{′} [ n ] = Base + \\ gradual\_increase ;\end{matrix} \\ \begin{matrix}else if ( If ( {y}^{′} [ n ] < \\ Base - Threshold )\end{matrix} & \begin{matrix}{y}^{′} [ n ] = Base + \\ gradual\_decrease ;\end{matrix} \\ Else & {y}^{′} [ n ] = {y}^{′} [ n ] ;\end{matrix} \qquad Compensation Equation 3$$

Here, y′[n] is the final target luminance of the current frame. Base is the reference target luminance. For example, the base may be the final target luminance y[n−1] of the previous frame. For example, Base may be an average value of target luminances of the plurality of frames up to the previous frame. gradient_increase may be the luminance value to be gradually increased, and gradient_decrease may be the luminance value to be gradually decreased.

For example, if the difference between the current target luminance and the previous target luminance exceeds a preset threshold in the reference target luminance (Base), the electronic device 101 may adjust display luminance by incrementally (e.g., gradually) increasing or decreasing the luminance instead of immediately reflecting luminance change. The electronic device 101 may prevent flickering that the user may perceive by incrementally (e.g., gradually) adjusting the target luminance through compensation. The electronic device 101 may incrementally (e.g., gradually gradually) change the target luminance by compensating for the target luminance.

FIG. 11 is a flowchart illustrating an example operation of performing HDR tone mapping by an electronic device 101 according to one or more embodiment(s). FIGS. 12A to 12C are views illustrating an example tone mapping curve used for HDR tone mapping by an electronic device 101 according to one or more embodiment(s).

In FIG. 11, the electronic device 101 may obtain a tone mapping curve corresponding to the input image data (operation 1110), adjust the tone mapping curve based on the OPR (operation 1120) and perform the HDR tone mapping on the target luminance using the adjusted tone mapping curve (operation 1130).

According to one or more embodiment(s), in operation 1110, the electronic device 101 may obtain an initial tone mapping curve corresponding to the input image data. For example, the initial tone mapping curve may be set based on the setting luminance of the display and the dynamic range of the input image data. For example, the initial tone mapping curve may be set by adjusting the relationship between the optical electrical transfer function (OETF) and the electrical optical transfer function (EOTF).

According to one or more embodiment(s), in operation 1120, the electronic device 101 may adjust the initial tone mapping curve based on the calculated OPR. For example, as illustrated in FIG. 12A, if the OPR is the same as the reference OPR, the electronic device 101 may use the first tone mapping curve in which the initial tone mapping curve is maintained. For example, if the set luminance of the display is the same as the HBM maximum luminance, or if it is not necessary to change the tone mapping curve due to the physical characteristics of the display, the electronic device 101 may perform HDR tone mapping on the target luminance using the first tone mapping curve.

For example, as illustrated in FIG. 12B, if the OPR is greater than the reference OPR, the electronic device 101 may adjust the initial tone mapping curve to a second tone mapping curve. For example, if the OPR is greater than the reference OPR, the second tone mapping curve may be adjusted to decrease the luminance of the image by a predetermined ratio. For example, if the OPR is greater than the reference OPR, the actual brightness of the display is likely to be lower than the set brightness due to the high proportion of emitting pixels, so the electronic device 101 may perform HDR tone mapping optimized for the high OPR using the second tone mapping curve.

For example, as illustrated in FIG. 12C, if the OPR is smaller (or less) than the reference OPR, the electronic device 101 may adjust the initial tone mapping curve to a third tone mapping curve. For example, if the OPR is smaller (or less) than the reference OPR, the third tone mapping curve may be adjusted to increase the luminance of the image by a predetermined ratio. For example, if the OPR is smaller (or less) than the reference OPR, the actual brightness of the display is likely to be higher than the setting luminance due to the low proportion of emitting pixels, so the electronic device 101 may perform HDR tone mapping optimized for the low OPR using the third tone mapping curve.

According to one or more embodiment(s), in operation 1130, the electronic device 101 may perform final HDR tone mapping using the adjusted tone mapping curve. For example, the electronic device 101 may adjust the brightness and color of the image to suit the target luminance by allowing each pixel of the input image data to emit light using the adjusted tone mapping curve.

As described above, the electronic device 101 of the disclosure may determine the target luminance considering the OPR along with the display set luminance, and perform HDR tone mapping based on the OPR.

Therefore, the electronic device 101 of the disclosure may minimize distortion of brightness and color in a self-luminous display such as AMOLED and display a high-quality HDR image that meets the content creator's intention.

However, since this has been described above, no duplicate description is given.

The electronic device according to one or more embodiment(s) of the disclosure may be one of various types of electronic devices. The electronic devices may include, for example, a portable communication device (e.g., a smartphone), a computer device, a portable multimedia device, a portable medical device, a camera, a wearable device, or a home appliance. According to one or more embodiment(s), the electronic devices are not limited to those described above.

It should be appreciated that one or more embodiment(s) of the disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used herein, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to one or more embodiment(s), the module may be implemented in a form of an application-specific integrated circuit (ASIC).

One or more embodiment(s) as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The storage medium readable by the machine may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to one or more embodiment(s), a method according to one or more embodiment(s) of the disclosure may be included and provided in a computer program product. The computer program products may be traded as commodities between sellers and buyers. The computer program product may be distributed in the form of a machine-readable storage medium (e.g., compact disc read only memory (CD-ROM)), or be distributed (e.g., downloaded or uploaded) online via an application store (e.g., Play Store™), or between two user devices (e.g., smartphones) directly. If distributed online, at least part of the computer program product may be temporarily generated or at least temporarily stored in the machine-readable storage medium, such as memory of the manufacturer's server, a server of the application store, or a relay server.

According to one or more embodiment(s), each component (e.g., a module or a program) of the above-described components may include a single entity or multiple entities. Some of the plurality of entities may be separately disposed in different components. According to one or more embodiment(s), one or more of the above-described components may be omitted, or one or more other components may be added. Alternatively or additionally, a plurality of components (e.g., modules or programs) may be integrated into a single component. In such a case, according to one or more embodiment(s), the integrated component may still perform one or more functions of each of the plurality of components in the same or similar manner as they are performed by a corresponding one of the plurality of components before the integration. According to one or more embodiment(s), operations performed by the module, the program, or another component may be carried out sequentially, in parallel, repeatedly, or heuristically, or one or more of the operations may be executed in a different order or omitted, or one or more other operations may be added.

In one or more embodiment(s), an electronic device may comprise a display, at least one processor, and memory storing instructions. The instructions may, when executed individually or collectively by at least one processor, cause the electronic device to calculate an OPR based on input image data, determine a target luminance based on the OPR and a display set luminance, perform HDR tone mapping, using the target luminance, to the input image data, and control the display to display an image corresponding to the input image data to which the HDR tone mapping is performed.

In one or more embodiment(s), the OPR may be calculated based on pixel values of each frame of the input image data.

In one or more embodiment(s), the instructions, when individually or collectively executed by at least one processor, may cause the electronic device to analyze pixel values of each frame of the input image data, and calculate at least one of (i) a ratio of emitting pixels to total pixels or (ii) an emitting degree based on the pixel values.

In one or more embodiment(s), the instructions, when individually or collectively executed by at least one processor, may cause the electronic device to determine whether the display set luminance is greater than an HBM maximum luminance, and based on the display set luminance being equal to or less than the HBM maximum luminance, determine the target luminance as the display set luminance.

In one or more embodiment(s), the instructions, when individually or collectively executed by at least one processor, may cause the electronic device to compare the OPR with a reference OPR, and based on the OPR being equal to the reference OPR, determine the target luminance as the display set luminance.

In one or more embodiment(s), the instructions, when individually or collectively executed by at least one processor, may cause the electronic device to compare the OPR with a reference OPR, and based on the OPR being greater than the reference OPR, set the target luminance to be lower than the display set luminance based on the OPR and the HBM maximum luminance. In one or more embodiment(s), the instructions may cause the electronic device to compare the OPR with a reference OPR, and based on the OPR being greater than the reference OPR, determine the target luminance using Equation 1 below.

$$Y = {HBM}_{max} + ( x - {HBM}_{max} ) ⋆ ( 1 - \frac{OPR \%}{100} ) \qquad Equation 1$$

In one or more embodiment(s), the instructions, when individually or collectively executed by at least one processor, may cause the electronic device to compare the OPR with a reference OPR, and based on the OPR being less than the reference OPR, calculate the target luminance to be higher than the display set luminance based on the OPR.

In one or more embodiment(s), the instructions, when individually or collectively executed by at least one processor, may cause the electronic device to compare the OPR with a reference OPR, and based on the OPR being less than the reference OPR, determine the target luminance using Equation 2 below.

$$Y = x + ( \frac{100}{OPR \%} ) * α \qquad Equation 2$$

In one or more embodiment(s), the instructions, when individually or collectively executed by at least one processor, may cause the electronic device to obtain illuminance data including an illuminance of a usage environment, and determine the target luminance by further considering the illuminance data in addition to the OPR and the display set luminance.

In one or more embodiment(s), the instructions, when individually or collectively executed by at least one processor, may cause the electronic device to analyze the target luminance for each frame of the input image data, and compensate the target luminance based on a first compensation method using an IIR filter.

In one or more embodiment(s), the instructions, when individually or collectively executed by at least one processor, may cause the electronic device to analyze the target luminance for each frame of the input image data and compensate for the target luminance using compensation equation 1 below.

$$y [ n ] = b\_ 0 ⋆ x [ n ] + b\_ 1 ⋆ x [ n - 1 ] + … + b\_N * x [ n - N ] ⋆ a\_ 1 * y [ n - 1 ] - … - a\_M * y [ n - M ] \qquad Compensation Equation 1$$

In one or more embodiment(s), the instructions, when individually or collectively executed by at least one processor, may cause the electronic device to analyze the target luminance for each frame of the input image data, and compensate the target luminance according to a first compensation method using an IIR filter.

In one or more embodiment(s), the instructions, when individually or collectively executed by at least one processor, may cause the electronic device to analyze the target luminance for each frame of the input image data, and compensate the target luminance based on a second compensation method using an average value of target luminances of a plurality of frames.

In one or more embodiment(s), the instructions, when individually or collectively executed by at least one processor, may cause the electronic device to analyze the target luminance for each frame of the input image data and compensate for the target luminance using compensation equation 2 below.

$${y}^{′} [ n ] = ( y [ n ] + y [ n - 1 ] + … + y [ n\_N ] ) / ( N + 1 ) \qquad Compensation Equation 2$$

In one or more embodiment(s), the instructions, when individually or collectively executed by at least one processor, may cause the electronic device to analyze the target luminance for each frame of the input image data, and compensate the target luminance based on a third compensation method so that the target luminance is incrementally changed using a reference target luminance.

In one or more embodiment(s), the instructions, when individually or collectively executed by at least one processor, may cause the electronic device to analyze the target luminance for each frame of the input image data and compensate for the target luminance using compensation equation 3 below.

$$\begin{matrix}\begin{matrix}If ( {y}^{′} [ n ] >= Base + \\ Threshold )\end{matrix} & \begin{matrix}{y}^{′} [ n ] = Base + \\ gradual\_increase ;\end{matrix} \\ \begin{matrix}else if ( If ( {y}^{′} [ n ] < \\ Base - Threshold )\end{matrix} & \begin{matrix}{y}^{′} [ n ] = Base + \\ gradual\_decrease ;\end{matrix} \\ Else & {y}^{′} [ n ] = {y}^{′} [ n ] ;\end{matrix} \qquad Compensation Equation 3$$

In one or more embodiment(s), the instructions may cause the electronic device to obtain a tone mapping curve corresponding to the input image data, adjust the tone mapping curve based on the OPR and perform HDR tone mapping on the target luminance using the adjusted tone mapping curve.

In one or more embodiment(s), the instructions, when individually or collectively executed by at least one processor, may cause the electronic device to render an image that reflects loading effect characteristics based on the OPR through the HDR tone mapping to display the image with reduced color distortion.

In one or more embodiment(s), the target luminance may be determined based further on display characteristics.

In one or more embodiment(s), a display method may comprise calculating an OPR based on input image data, determining a target luminance based on the OPR and a display set luminance, performing HDR tone mapping, using the target luminance, to the input image data, and displaying an image corresponding to the input image data to which the HDR tone mapping is performed.

In one or more embodiment(s), determining the target luminance may include determining whether the display set luminance is greater than an HBM maximum luminance, and based on the display set luminance being equal to or less than the HBM maximum luminance, determining the target luminance as the display set luminance.

In one or more embodiment(s), determining the target luminance may include comparing the OPR with a reference OPR, and based on the OPR being equal to the reference OPR, determining the target luminance as the display set luminance.

In one or more embodiment(s), determining the target luminance may include comparing the OPR with a reference OPR, and based on the OPR being greater than the reference OPR, determining the target luminance using Equation 1 below.

$$Y = {HBM}_{max} + ( x - {HBM}_{max} ) ⋆ ( 1 - \frac{OPR \%}{100} ) \qquad Equation 1$$

In one or more embodiment(s), determining the target luminance may include comparing the OPR with a reference OPR, and based on the OPR being less than the reference OPR, determining the target luminance using Equation 2 below.

$$Y = x + ( \frac{100}{OPR \%} ) * α \qquad Equation 2$$

In one or more embodiment(s), determining the target luminance may include analyzing the target luminance for each frame of the input image data and compensating for the target luminance using compensation equation 1 below.

$$y [ n ] = b\_ 0 ⋆ x [ n ] + b\_ 1 ⋆ x [ n - 1 ] + … + b\_N * x [ n - N ] ⋆ a\_ 1 * y [ n - 1 ] - … - a\_M * y [ n - M ] \qquad Compensation Equation 1$$

In one or more embodiment(s), determining the target luminance may include analyzing the target luminance for each frame of the input image data and compensating for the target luminance using compensation equation 2 below.

$${y}^{′} [ n ] = ( y [ n ] + y [ n - 1 ] + … + y [ n\_N ] ) / ( N + 1 ) \qquad Compensation Equation 2$$

In one or more embodiment(s), performing the HDR tone mapping may include obtaining a tone mapping curve corresponding to the input image data, adjusting the tone mapping curve based on the OPR, and performing HDR tone mapping on the target luminance using the adjusted tone mapping curve.

While the disclosure has been illustrated and described with reference to various example embodiments, it will be understood that the various example embodiments are intended to be illustrative, not limiting. It will be further understood by those skilled in the art that various changes in form and detail may be made without departing from the true spirit and full scope of the disclosure, including the appended claims and their equivalents. It will also be understood that any of the embodiment(s) described herein may be used in conjunction with any other embodiment(s) described herein.

What is claimed is:

1. An electronic device comprising:
a display;
at least one processor; and
memory storing one or more instructions that, when individually or collectively executed by the at least one processor, cause the electronic device to:
obtain an on-pixel ratio (OPR) based on input image data,
determine a target luminance based on the OPR and a display set luminance,
perform HDR tone mapping, using the target luminance, on the input image data, and
control the display to display an image corresponding to the input image data on which HDR tone mapping is performed.

2. The electronic device of claim 1, wherein the OPR is obtained based on pixel values of each frame of the input image data.

3. The electronic device of claim 1, wherein the one or more instructions, when individually or collectively executed by the at least one processor, further cause the electronic device to:
analyze pixel values of each frame of the input image data, and
obtain, based on the pixel values, at least one of a ratio of emitting pixels to total pixels or an emitting degree.

4. The electronic device of claim 1, wherein the one or more instructions, when individually or collectively executed by the at least one processor, further cause the electronic device to:
based on the display set luminance being equal to or less than a high brightness mode (HBM) maximum luminance, identify the target luminance as the display set luminance.

5. The electronic device of claim 4, wherein the one or more instructions, when individually or collectively executed by the at least one processor, further cause the electronic device to:
compare the OPR with a reference OPR, and
based on the OPR being equal to the reference OPR, identify the target luminance as the display set luminance.

6. The electronic device of claim 4, wherein the one or more instructions, when individually or collectively executed by the at least one processor, further cause the electronic device to:
compare the OPR with a reference OPR, and
based on the OPR being greater than the reference OPR, set the target luminance to be lower than the display set luminance.

7. The electronic device of claim 4, wherein the one or more instructions, when individually or collectively executed by the at least one processor, further cause the electronic device to:
compare the OPR with a reference OPR, and
based on the OPR being less than the reference OPR, set the target luminance to be higher than the display set luminance.

8. The electronic device of claim 1, wherein the one or more instructions, when individually or collectively executed by the at least one processor, further cause the electronic device to:
obtain illuminance data comprising an illuminance of a usage environment, and
determine the target luminance based on the illuminance data, the OPR, and the display set luminance.

9. The electronic device of claim 1, wherein the one or more instructions, when individually or collectively executed by the at least one processor, further cause the electronic device to:
analyze the target luminance of each frame of the input image data, and
compensate the target luminance based on a first compensation method using an infinite impulse response (IIR) filter.

10. The electronic device of claim 1, wherein the one or more instructions, when individually or collectively executed by the at least one processor, further cause the electronic device to:
analyze the target luminance of each frame of the input image data, and
compensate the target luminance based on a second compensation method using an average value of target luminances of each frame of the input image data.

11. The electronic device of claim 1, wherein the one or more instructions, when individually or collectively executed by the at least one processor, further cause the electronic device to:
analyze the target luminance for each frame of the input image data, and
compensate the target luminance based on a third compensation method comprising incremental change of the target luminance based on a reference target luminance.

12. The electronic device of claim 1, wherein the one or more instructions, when individually or collectively executed by the at least one processor, further cause the electronic device to:
obtain a tone mapping curve corresponding to the input image data,
adjust the tone mapping curve based on the OPR, and
perform HDR tone mapping on the target luminance using the adjusted tone mapping curve.

13. The electronic device of claim 1, wherein the one or more instructions, when individually or collectively executed by the at least one processor, further cause the electronic device to:
render an image that reflects loading effect characteristics based on the OPR through the HDR tone mapping, and
display the rendered image on the display.

14. The electronic device of claim 1, wherein the one or more instructions, when individually or collectively executed by the at least one processor, further cause the electronic device to determine the target luminance based on the OPR, the display set luminance, and characteristics of the display.

15. A method of displaying an image, the method comprising:
obtaining an on-pixel ratio (OPR) based on input image data;
determining a target luminance based on the OPR and a display set luminance;
performing HDR tone mapping, using the target luminance, on the input image data; and
displaying an image corresponding to the input image data on which HDR tone mapping is performed.

16. The method of claim 15, wherein the OPR is obtained based on pixel values of each frame of the input image data.

17. The method of claim 15, wherein the determining the target luminance comprises:
based on the display set luminance being equal to or less than a high brightness mode (HBM) maximum luminance, identifying the target luminance as the display set luminance.

18. The method of claim 17, wherein the determining the target luminance further comprises:
comparing the OPR with a reference OPR; and
based on the OPR being equal to the reference OPR, identifying the target luminance as the display set luminance.

19. The method of claim 17, wherein the determining the target luminance further comprises:
comparing the OPR with a reference OPR; and
based on the OPR being greater than the reference OPR, setting the target luminance to be lower than the display set luminance.

20. The method of claim 17, wherein the determining the target luminance further comprises:
comparing the OPR with a reference OPR; and
based on the OPR being less than the reference OPR, setting the target luminance to be higher than the display set luminance.
